(19) United States
(12) Patent Application Publication
(10) Pub. No.: US 2026/0358583 A1
(43) Pub. Date: Nov. 12, 2026

(54) MULTI-CORE FIBER BUNDLE, CONNECTOR, AND ADAPTOR FOR PHOTONIC INTERCONNECTION

(71) Applicant: Applied Materials, Inc., Santa Clara, CA (US)

(72) Inventors: Hou T. NG, Campbell, CA (US); Nag PATIBANDLA, Santa Clara, CA (US); Mingwei ZHU, San Jose, CA (US); Peiwen LIU, Fremont, CA (US); Jianfeng SUN, Milpitas, CA (US); Kulandaivelu SIVANANDAN, Sunnyvale, CA (US); Yongwook KIM, Sunnyvale, CA (US); Lisong XU, Santa Clara, CA (US); Hyunsung BANG, Sunnyvale, CA (US); Cong CHEN, Cupertino, CA (US); Jeffrey L. FRANKLIN, Santa Clara, CA (US); Kai DING, Cupertino, CA (US)

(21) Appl. No.: 19/650,019

(22) Filed: Apr. 16, 2026

Related U.S. Application Data
(60) Provisional application No. 63/790,570, filed on Apr. 17, 2025.

(51) Int. Cl. G02B 6/42

(52) U.S. Cl. CPC G02B 6/4249; G02B 6/4239

(57) ABSTRACT

An optical system and method of forming a fiber array are provided. The method includes forming a plurality of fiber cores within a build volume using a light-based curing system, introducing and curing one or more additional materials to form cladding and structural features surrounding the fiber cores, and actuating a build stage relative to a base support to form a three-dimensional fiber array structure. In some embodiments, the fiber array is formed using additive manufacturing processes, including multi-material and voxel-based fabrication techniques. The resulting fiber array may include integrated alignment features, connectors, or reinforcement structures. The optical system includes a fiber array positioned relative to a plurality of light emitting devices and/or photodetectors to enable optical coupling. Improved control of fiber geometry, alignment, and spacing enhances optical coupling efficiency and overall system performance.

### PRIORITY CLAIM

This application claims priority to and the benefit of U.S. Provisional Patent Application No. 63/790,570, filed Apr. 17, 2025, which is hereby incorporated by reference in its entirety.

### BACKGROUND

### Field

Embodiments of the present disclosure generally relate to a method of producing a high precision multi-core fiber array.

### Description of the Related Art

Optical systems that utilize fiber arrays are commonly employed to transmit optical signals between components, including light emitting devices and photodetectors. In many applications, increasing demands for bandwidth and data throughput have led to the use of fiber arrays having a high density of optical channels within a compact footprint. Such fiber arrays may be used in conjunction with device arrays, including micro-light emitting diodes (micro-LEDs), vertical cavity surface emitting lasers (VCSELs), and photodetector arrays, to enable parallel transmission of optical signals.

In some cases, performance of such optical systems may depend on precise alignment between fibers of a fiber array and corresponding optical components. As the density of fibers increases, for example in fiber arrays including fibers having diameters on the order of less than about 50 micrometers, sensitivity to positional variation may also increase. Misalignment between the fiber array and associated optical components may result in reduced coupling efficiency and degraded signal transmission.

Conventional approaches for forming and integrating fiber arrays may involve multiple fabrication and assembly steps, including formation of individual components followed by alignment and attachment. Such approaches may introduce variability due to handling, processing tolerances, and cumulative alignment errors. Additionally, integration of fiber arrays with other system components, including backplanes and device arrays, may present challenges in achieving repeatable and precise alignment while maintaining structural integrity.

Accordingly, there is a need for improved 3D printing methods of fiber arrays with high precision, allowing for direct integration with additional optical components.

### SUMMARY

In an embodiment of the present disclosure, a method of forming a fiber array is provided. The method comprises introducing a core resin into a build volume between a base support and a build stage, selectively curing portions of the core resin using a light-based curing system to form a plurality of cured resin cores, introducing a cladding resin into the build volume, and curing the cladding resin to form cured cladding resin surrounding the plurality of cured resin cores. The method further comprises actuating the build stage relative to the base support along a build direction to control a build height to form a three-dimensional fiber array structure.

In another embodiment of the present disclosure, a method of forming a fiber array is provided. The method comprises building a fiber array core on a substrate, removing excess resin and cleaning the fiber array core, filling the fiber array core with a cladding resin, retrieving the fiber array core from the substrate, polishing one or more ends of the fiber array core, and attaching one or more alignment members to the fiber array core.

In yet another embodiment of the present disclosure, an optical system is provided. The optical system comprises a backplane, a plurality of micro-light emitting devices disposed relative to the backplane, and a fiber array positioned relative to the backplane and the plurality of micro-light emitting devices such that individual fibers of the fiber array are aligned with corresponding light emitting elements of the plurality of micro-light emitting devices to optically couple light from the plurality of micro-light emitting devices into the fiber array, wherein the fiber array comprises a plurality of fiber cores and a cladding layer surrounding the plurality of fiber cores.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIGS. 1A-1D illustrate an example optical system and associated fiber array structures, with FIG. 1A showing an overall optical system, FIG. 1B showing a cross-sectional view of a fiber array, FIG. 1C showing a first end of the fiber array aligned with a light emitting device array, and FIG. 1D showing a second end of the fiber array aligned with a photodetector array.

FIG. 2 illustrates a fabrication system configured to form a fiber array, according to embodiments of the present disclosure.

FIG. 3 illustrates a fabrication process for forming a fiber array using a light-based fabrication platform, according to embodiments disclosed herein.

FIGS. 4A and 4B illustrate embodiments of a fiber array including an alignment member.

FIGS. 5A and 5B illustrate an alternative embodiment of a fabrication system and process using a laser-based scanning approach.

FIG. 6 illustrates a flow diagram of an embodiment of a fabrication process for forming a fiber array using a substrate-based fabrication and post-processing approach.

FIGS. 7A-7C illustrate an implementation of the fabrication process of FIG. 6, according to embodiments disclosed herein.

FIGS. 8A-8C illustrate an alternate implementation of the fabrication process of FIG. 6, according to embodiments disclosed herein.

FIG. 9 illustrates a structural embodiment of a fiber array formed on a substrate, according to embodiments disclosed herein.

FIGS. 10A-10C illustrate an optical system including a fiber array integrated with system-level components, according to embodiments disclosed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to a method of producing a high precision multi-core fiber array for transmitting optical signals between components. In such systems, performance may be influenced by the geometry, density, and alignment of fibers within a fiber array, as well as the integration of the fiber array with light emitting and light receiving components.

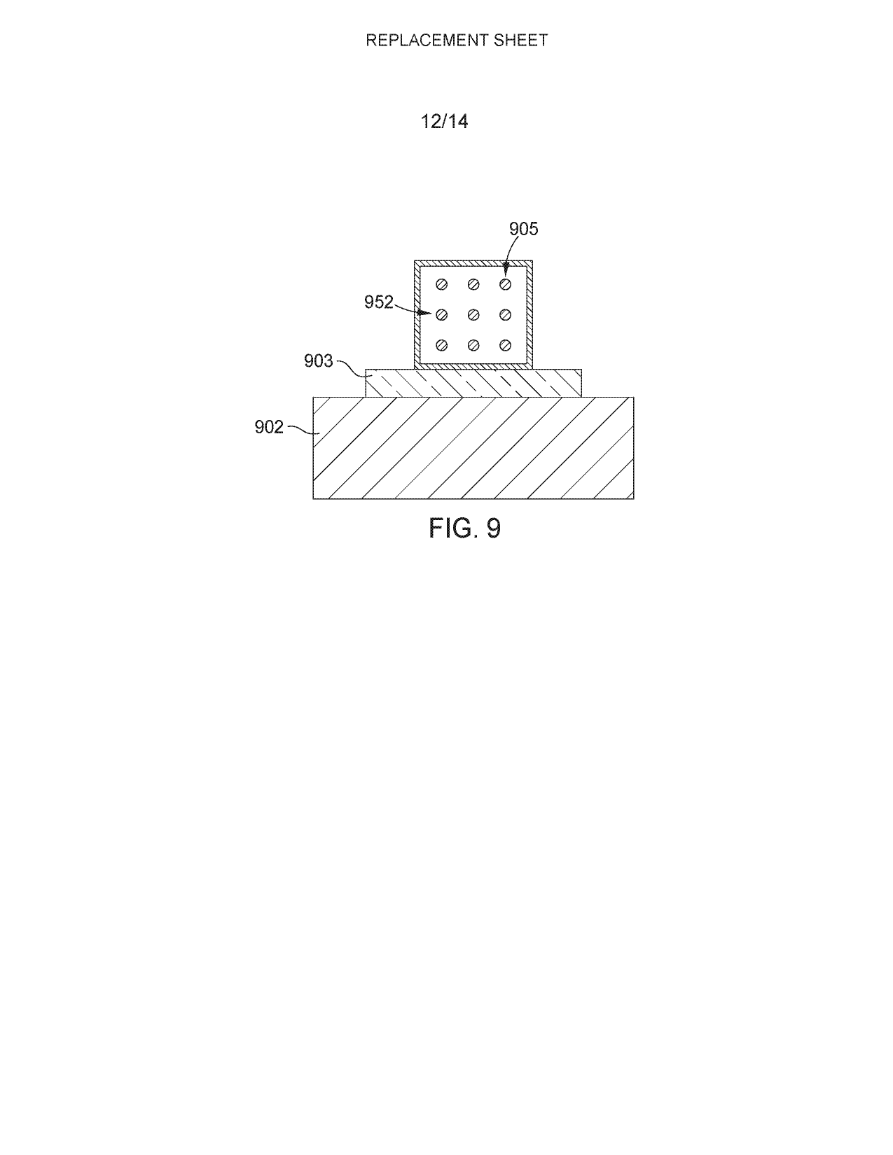

FIGS. 1A-1D illustrate an example optical system and associated fiber array structures that highlight precision considerations in optical alignment. FIG. 1A shows an overall optical system 100, FIG. 1B shows a cross-sectional view of a fiber array 105, FIG. 1C shows a first end 113 of the fiber array 105 aligned with a light emitting device array 103, and FIG. 1D shows a second end 114 of the fiber array 105 aligned with a photodetector array 104.

Referring to FIG. 1A, the optical system 100 comprises a fiber array 105 configured to transmit optical signals between a light emitting device array 103 and a photodetector array 104. The optical system 100 may further comprise an interposer 101 and a substrate 102 that support and electrically couple system components. In some embodiments, the interposer 101 provides routing and interconnection between the light emitting device array 103, the photodetector array 104, and other system components. A controller 110 may be operatively coupled to the optical system 100 to control operation of the light emitting device array 103 and/or process signals received from the photodetector array 104. In some embodiments, a signal measuring device 119 may be coupled to the optical system 100 to monitor optical or electrical signals associated with system performance. Improved alignment and control of spacing between the fiber array 105 and the light emitting device array 103 and the photodetector array 104 may be utilized by the controller 110 and/or the signal measuring device 119 to enhance signal quality, coupling efficiency, and overall system performance.

The fiber array 105 extends between the light emitting device array 103 and the photodetector array 104. As shown in FIG. 1B, the fiber array 105 comprises a plurality of fibers 105A configured to guide optical signals. The fiber array 105 may be characterized by a fiber array length 106 and a fiber array width 107, which together define an overall geometry and footprint of the fiber array 105. In some embodiments, one or more protective or structural features may be included, such as a cap 125 disposed at one or more ends of the fiber array 105 and a fiber barrier 128 configured to provide separation or protection between fibers or between the fiber array 105 and surrounding structures.

The plurality of fibers 105A may be arranged in a high-density configuration to enable parallel transmission of optical signals. In some embodiments, the fibers 105A are closely spaced, such as at pitches corresponding to fiber diameters on the order of less than about 50micrometers, thereby enabling high-bandwidth optical communication within a compact footprint.

FIG. 1C illustrates a first end 113 of the fiber array 105 positioned relative to the light emitting device array 103. The plurality of fibers 105A are aligned with corresponding light emitting devices of the light emitting device array 103. A gap distance 120A between the light emitting device array 103 and the first end 113 of the fiber array 105 may influence optical coupling efficiency. Variations in the gap distance 120A and alignment between the fibers 105A and the light emitting device array 103 may result in reduced coupling efficiency and increased optical losses.

FIG. 1D illustrates a second end 114 of the fiber array 105 positioned relative to the photodetector array 104. The plurality of fibers 105A are aligned with corresponding photodetectors of the photodetector array 104. A gap distance 120B between the photodetector array 104 and the second end 114 of the fiber array 105 may influence reception efficiency of optical signals. Variations in the gap distance 120B and alignment between the fibers 105A and the photodetector array 104 may result in reduced signal detection efficiency.

As illustrated in FIGS. 1A-1D, performance of the optical system 100 is influenced by the geometry and alignment of the fiber array 105, including positioning of the fibers 105A relative to corresponding optical components and control of gap distances 120A and 120B. In high-density configurations, small variations in alignment or spacing may significantly impact optical performance. Embodiments of the present disclosure enable improved control over fiber geometry, alignment, and integration with system components to enhance optical coupling efficiency and system performance.

FIG. 2 illustrates a fabrication system 200 configured to form the fiber array 105, according to embodiments of the present disclosure. In some embodiments, the fabrication system 200 corresponds to an additive manufacturing system, such as a three-dimensional (3D) printing system, configured to form the fiber array 105 using a multi-material, light-curable fabrication process. Such processes may comprise layer-by-layer, volumetric, or voxel-based curing approaches that enable precise spatial control of material placement and geometry. The additive manufacturing system may be configured to selectively deposit and cure materials within a build volume to form three-dimensional structures. The fabrication system 200 utilizes light-based processing, such as digital light projection (DLP)-based systems, laser-based scanning systems, or other light-based curing systems, to achieve precise geometries and alignment characteristics at micron and sub-micron scales.

As discussed in further detail below, the illustrated embodiment of the fabrication system 200 comprises a base support 212 and a build stage 216 positioned relative to the base support 212. A build volume 218 is defined between the base support 212 and the build stage 216. The build stage 216 provides a surface upon which structures may be formed, while the base support 212 provides support for materials disposed within the build volume 218. In some embodiments, the base support 212 may be configured to allow transmission of light therethrough and to provide a physical barrier between the core resin 214 disposed in the build volume 218 and a digital light projection (DLP) module 210 positioned below the base support 212. A build direction 222 defines a direction along which the fiber array 105 is formed within the build volume 218.

A core resin 214 may be introduced into the build volume 218. The core resin 214 may comprise a light-curable material configured to form one or more portions of the fiber array 105. In some embodiments, the core resin 214 comprises a high refractive index material suitable for forming optical cores. In addition to the core resin 214, additional materials may be introduced, removed, or replaced within the build volume 218 during fabrication, including cladding resins, protective resins, and structural resins. In some embodiments, fabrication may be performed using multiple distinct resins corresponding to core, cladding, protective, and structural materials. In other embodiments, a single resin system may be used, wherein selective curing conditions and process control define different functional regions within the fiber array. The cladding resins may comprise lower refractive index materials, while the protective and structural resins may provide mechanical support and environmental protection. Sequential introduction and selective curing of different materials enables formation of multi-material fiber structures with controlled optical properties. In some embodiments, the structural resins are configured to form alignment and reinforcement structures that provide mechanical stability and dimensional control of the fiber array during and after fabrication.

The fabrication system 200 further comprises a light-based curing system, such as a digital light projection (DLP) module 210 configured to selectively cure materials disposed within the build volume 218. The DLP module 210 may project patterned light into spatially defined regions of the build volume 218 to selectively cure portions of the core resin 214 and other materials based on a desired geometry. In some embodiments, the DLP module 210 may comprise or be replaced by other light-based systems, including laser-based scanning systems, voxel-based curing systems, or combinations thereof, to achieve selective material curing in either a layer-by-layer manner or a volumetric manner.

The fabrication system 200 also comprises an elevator 220 coupled to the build stage 216. The elevator 220 is configured to actuate the build stage 216 relative to the base support 212 with high precision. In some embodiments, the elevator 220 provides high precision motion along the build direction 222 to enable controlled incremental formation of structures. In some embodiments, the elevator 220 may be configured to actuate the build stage 216 in vertical directions, horizontal directions, or combinations thereof. Movement of the build stage 216 relative to the base support 212 enables formation of three-dimensional structures within the build volume 218 through sequential or continuous curing of materials.

The fabrication system 200 enables formation of the fiber array 105 through controlled introduction and selective curing of materials within the build volume 218 to form a three-dimensional fiber array structure. The ability to control material placement and curing at fine spatial resolutions enables formation of fiber arrays having precise geometries and alignment characteristics. As described in greater detail with respect to FIG. 3, the fiber array 105 may be formed through a sequence of operations performed using the fabrication system 200.

FIG. 3 illustrates an embodiment of the present disclosure of a fabrication process 300 for forming a fiber array 305 using a light-based fabrication platform. The fabrication process 300 may be performed using elements analogous to those described with respect to FIG. 2, including a digital light projection (DLP) module 310, a base support 312, a build stage 316, a build volume 318, an elevator 320, and a build direction 322. A build height 324 corresponds to a dimension of the structure being formed along the build direction 322.

A first operation 330 comprises introducing a core resin 314 into the build volume 318. In some embodiments, the core resin 314 comprises one or more photoinitiators configured to initiate polymerization upon exposure to light from the DLP module 310. The core resin 314 may also be selected to exhibit flow characteristics suitable for filling regions of the build volume 318 surrounding previously formed structures. The core resin 314 may comprise a light-curable material suitable for forming optical cores, and in some embodiments comprises a material having a relatively higher refractive index compared to surrounding materials. For example, the core resin 314 may comprise polymers, polymethyl methacrylate (PMMA), PMMA-like materials, polyolefins, halogenated resins, resins with aromatic groups, sulfated resins, norbornene-based resins, perfluorinated arylates, SU8-based resins, or combinations thereof.

A second operation 332 comprises selectively curing portions of the core resin 314 using the DLP module 310 to form a plurality of cured resin cores 350 (fiber cores). Exposure parameters of the DLP module 310, including intensity, duration, and spatial pattern, may be controlled to achieve partial or complete curing of the core resin 314 in desired regions. In some embodiments, the DLP module 310 may be actuated or aligned relative to the build stage 316 during curing to maintain positional accuracy between patterned light and the fiber array 305 as the build height 324 increases. The DLP module 310 may project patterned light through the base support 312 and into the build volume 318 to cure spatially defined regions of the core resin 314 corresponding to the geometry and spacing of the fiber cores 350. In this manner, the fiber cores 350 may be formed with high precision and arranged in a desired architecture for the fiber array 305.

A third operation 334 comprises introducing a cladding resin 352 into the build volume 318. In some embodiments, the cladding resin 352 is selected to flow into regions surrounding the fiber cores 350 to ensure complete encapsulation prior to curing. The cladding resin 352 may comprise a light-curable material having a lower refractive index relative to the core resin 314 to facilitate optical confinement within the fiber cores 350. For example, the cladding resin 352 may comprise fluorinated acrylates, fluoro-urethane resins, silsesquioxane, fluoro silicone, or combinations thereof.

A fourth operation 336 comprises curing the cladding resin 352 to form cured cladding resin 354 surrounding the fiber cores 350. Selective curing of the cladding resin 352 may be performed using the DLP module 310 to define a cladding region with controlled thickness and geometry. In some embodiments, the cured cladding resin 354 is formed around outer surfaces of the fiber cores 350 such that the fiber cores 350 are surrounded by the cured cladding resin 354.

A fifth operation 338 comprises introducing a protective resin 356 into the build volume 318. The protective resin 356 may comprise a material configured to provide mechanical support, environmental protection, or both for the fiber array structure. In some embodiments, the protective resin 356 comprises acrylates or other light-curable protective coating materials.

A sixth operation 340 comprises curing the protective resin 356 to form a cured protective resin 358 surrounding the cladding region. The cured protective resin 358 may provide structural integrity and facilitate handling of the fiber array 305. In some embodiments, the cured protective resin 358 is formed around outer surfaces of the cured cladding resin 354 such that the cured cladding resin 354 is surrounded by the cured protective resin 358.

A seventh operation 342 comprises actuating the build stage 316 relative to the base support 312 using the elevator 320 along the build direction 322 to control the build height 324. In some embodiments, incremental actuation of the build stage 316 corresponds to a layer thickness of material formed during each repetition of operations 330-340, thereby enabling control of feature resolution along the build direction 322. In some embodiments, the DLP module 310 may be correspondingly adjusted or aligned with the build stage 316 during actuation to maintain consistent exposure alignment throughout formation of the fiber array 305. In some embodiments, the build stage 316 is actuated in a direction opposite the base support 312. The actuation may be continuous or step-wise, and may be performed with high precision to incrementally increase the build height 324. In some embodiments, the build direction 322 is vertical. In some embodiments, the build direction 322 is horizontal. Actuation of the build stage 316 enables formation of additional portions of the fiber array 305 through repetition of one or more of operations 330-340, thereby extending the fiber array 305 along the build direction 322 until a desired build height 324 is reached.

As a result of the fabrication process 300, a fiber array 360 is formed. In some embodiments, one or more portions of the fiber array 360, including the fiber cores 350, the cured cladding resin 354, and the cured protective resin 358, may be formed in situ during the fabrication process 300. In some embodiments, portions of the fiber cores 350, the cladding resin 352, and the protective resin 356 may be formed sequentially or concurrently depending on desired fabrication parameters. The fiber array 360 may comprise a plurality of fiber cores 350 surrounded by cured cladding resin 354 and further surrounded by cured protective resin 358. In some embodiments, additional operations may be performed on the fiber array 360, including introducing and curing one or more structural resins to form supporting members extending along or around the fiber array 360 to increase mechanical rigidity and dimensional stability. Such supporting members may be formed integrally with the fiber array 360 during the fabrication process 300 or added in subsequent operations. In some embodiments, additional operations may be performed to form integrated alignment features on one or more ends or along a length of the fiber array 360, the alignment features configured to facilitate passive or active alignment with external optical components. In some embodiments, connector structures may also be formed integrally with the fiber array 360 to enable direct coupling to other devices. In some embodiments, support or contact structures used during fabrication may be configured with sufficiently small dimensions to minimize optical loss within the fiber cores. In some embodiments, formation of the fiber cores, cladding, and surrounding structures may be performed in an alternating or interleaved manner, such that portions of the cladding and core materials are sequentially formed during the build process. In some embodiments, one or more ends of the fiber array 360 may be polished.

FIGS. 4A and 4B illustrate embodiments of a fiber array 460 including an alignment member 425. FIGS. 4A and 4B show respective vertical and horizontal alignment configurations for the fiber array 460, showing an alignment member 425 formed at an end of the fiber array 460. The fiber array 460 may correspond to the fiber array 360 described with respect to FIG. 3, and may be formed using the fabrication system 200 and fabrication process 300 described herein.

As shown in FIGS. 4A and 4B, the alignment member 425, such as a cap, may be formed at an end of the fiber array 460. The alignment member 425 may be configured to facilitate alignment of the fiber array 460 with one or more external components, such as light emitting device arrays, photodetector arrays, or other optical systems. In some embodiments, the alignment member 425 comprises one or more features configured to provide passive alignment, active alignment, or combinations thereof. In some embodiments, the alignment member 425 comprises one or more fiducial features configured to provide reference points for alignment of the fiber array 460 relative to external components. The fiducial features may comprise optically detectable patterns, geometric markers, or other reference structures configured to facilitate alignment using imaging systems, mechanical alignment systems, or combinations thereof. In some embodiments, the fiducial features are formed integrally with the alignment member 425 during the fabrication process 300, thereby improving positional accuracy and reducing alignment variability.

In some embodiments, the alignment member 425 may be formed integrally with the fiber array 460 using the fabrication system 200 and fabrication process 300. For example, the alignment member 425 may be formed through introduction and selective curing of one or more structural resins within the build volume 318 during or after formation of the fiber cores 350, the cured cladding resin 354, and the cured protective resin 358. In this manner, the alignment member 425 may be formed in situ with the fiber array 460 to reduce alignment variability associated with post-fabrication attachment processes.

In some embodiments, the alignment member 425 may comprise one or more structural features extending from or surrounding the fiber array 460 to provide mechanical support and positional stability. The alignment member 425 may also comprise features configured to interface with complementary structures of external components, including recesses, protrusions, or other mating geometries.

FIGS. 5A and 5B illustrate an embodiment of a fabrication system 500 and fabrication process for forming a fiber array 560 using a laser-based scanning approach. FIGS. 5A and 5B show laser-based fabrication of a fiber array, with FIG. 5A showing operation of a laser-based scanning system 510 within a build volume 518 and FIG. 5B showing resulting structures of the fiber array 560 including a core separator 562 and a bundle sleeve 564. The fabrication system 500 may provide an alternative embodiment to the fabrication system 200 and fabrication process 300 described with respect to FIGS. 2 and 3, while enabling formation of similar fiber array structures.

The fabrication system 500 comprises a laser-based scanning system 510 configured to generate a directed laser beam 511. The directed laser beam 511 may be scanned within a build volume 518 to selectively cure materials disposed therein. The fabrication system 500 further comprises a base support 512, a build stage 516, and a build direction 522 along which structures may be formed.

A first operation 530 comprises introducing a core resin 514 into the build volume 518. The core resin 514 may comprise a light-curable material similar to the core resin 314 described with respect to FIG. 3.

A second operation 532 comprises selectively curing portions of the core resin 514 using the directed laser beam 511 to form fiber core regions. The laser-based scanning system 510 may scan the directed laser beam 511 within the build volume 518 to define spatially localized cured regions corresponding to the fiber cores. In some embodiments, curing may occur at focal regions of the directed laser beam 511 to enable high-resolution formation of the fiber cores.

A third operation 534 comprises introducing additional resins into the build volume 518 as the build stage 516 is actuated along the build direction 522. The additional resins may comprise materials configured to form surrounding structures of the fiber array 560. In some embodiments, the additional resins are introduced into regions between the base support 512 and the build stage 516 as the build stage 516 is moved.

In some embodiments, the additional resins are selectively cured using the directed laser beam 511 to form the fiber array 560 as a build height is reached. The curing of the additional resins may result in formation of structures including a core separator 562 and a bundle sleeve 564. The core separator 562 and the bundle sleeve 564 may be implemented to enhance rigidity of the fiber array 560 while retaining flexibility.

In some embodiments, the fabrication process illustrated in FIGS. 5A and 5B may be performed in a continuous or semi-continuous manner, with the directed laser beam 511 scanning within the build volume 518 while the build stage 516 is actuated. In this manner, the fiber array 560 may be formed through localized curing without requiring patterned projection of light.

The fiber array 560 formed using the fabrication system 500, as illustrated in FIGS. 5A and 5B, may comprise structures analogous to those described with respect to FIG. 3, including fiber cores and surrounding materials, while providing an alternative fabrication approach that enables fine spatial control and flexibility in forming complex geometries.

FIG. 6 illustrates an embodiment of the present disclosure of a fabrication process 600 for forming a fiber array using a substrate-based fabrication and post-processing approach. FIG. 6 shows a sequence of operations for forming and processing the fiber array, with a first operation 610 showing building a fiber array core on a substrate, a second operation 620 showing resin removal and cleaning, a third operation 630 showing filling the fiber array with cladding resin, a fourth operation 640 showing retrieving the fiber array from the substrate, a fifth operation 650 showing polishing ends of the fiber array, and a sixth operation 660 showing attachment of alignment members to the fiber array.

The fabrication process 600 may be performed to form a fiber array structure on a substrate and subsequently process the fiber array structure to enable integration with external optical components. The fabrication process 600 may be performed using one or more of the fabrication techniques described with respect to FIGS. 2-5, or using other suitable fabrication techniques. In some embodiments, the fabrication process may comprise post-processing steps associated with three-dimensional (3D) printed structures.

A first operation 610 comprises building a fiber array core 705 on a substrate 702. As illustrated in FIG. 7A, the fiber array core 705 may be formed over a sacrificial layer 703 disposed on the substrate 702. The sacrificial layer 703 facilitates subsequent removal of the fiber array core 705 from the substrate 702 after fabrication. In some embodiments, a supporting frame 710 is formed concurrently with or prior to formation of the fiber array core 705. The supporting frame 710 is configured to maintain structural integrity of the fiber array core 705 during the fabrication process, particularly as the fiber array core 705 increases in length. In some embodiments, the supporting frame 710 is coupled to the fiber array core 705 at locations selected to minimize optical interference while providing mechanical support.

A second operation 620 comprises removing excess resin and cleaning the fiber array core. In some embodiments, resin removal may comprise removing uncured or partially cured materials from interstitial regions between closely spaced fiber cores to enable subsequent uniform cladding infiltration. In some embodiments, resin removal may comprise removing uncured or partially cured materials from regions between or around the fiber cores. Cleaning may comprise rinsing, solvent exposure, or other techniques to prepare the fiber array core for subsequent processing steps. As illustrated in FIG. 7B, which shows a cross-sectional view of the fiber array core after cleaning, cleaning the fiber array core 705 may expose regions between the fiber cores to enable subsequent material introduction.

A third operation 630 comprises filling the fiber array with a cladding resin. The cladding resin may be introduced to ensure substantially complete filling of interstitial regions between fiber cores and to minimize formation of voids within the fiber array. The cladding resin may be introduced into regions surrounding the fiber cores to provide optical confinement and structural support. In some embodiments, the cladding resin is introduced to surround the fiber array core 705 and regions between the fiber array core 705 and the supporting frame 710. In some embodiments, the cladding resin is subsequently cured to form a cladding region surrounding the fiber cores. As further illustrated in FIG. 7C, which shows introduction of cladding around the fiber cores, a cladding resin 752 may be introduced to surround the fiber array core 705 following cleaning.

A fourth operation 640 comprises retrieving the fiber array from the substrate. In some embodiments, retrieving the fiber array comprises separating the fiber array from the substrate in a controlled manner to preserve structural integrity of the fiber array. In some embodiments, retrieving the fiber array comprises separating the fiber array from the substrate using mechanical, chemical, or other release techniques. As illustrated in FIG. 7C, which shows a released fiber array structure after separation from the substrate, the fiber array core 705 may be separated from the substrate 702, for example by removing or otherwise releasing the sacrificial layer 703.

A fifth operation 650 comprises polishing one or more ends of the fiber array. Polishing may be performed to form substantially planar end surfaces across a plurality of fiber cores to improve optical coupling efficiency. Polishing may be performed to improve optical coupling efficiency and to prepare end surfaces of the fiber array for alignment with external optical components. As further illustrated in FIG. 7C, which also shows polished end surfaces of the fiber array, polishing may form one or more polished end surfaces of the fiber array core 705.

A sixth operation 660 comprises attaching one or more alignment members to the fiber array. The alignment members may correspond to the alignment members described with respect to FIG. 4 and may be configured to facilitate alignment of the fiber array with external optical components. As illustrated in FIG. 7C, which further shows alignment members coupled to the fiber array, one or more alignment members may be coupled to the fiber array core 705 to form a resulting fiber array structure.

FIGS. 8A-8C illustrate an alternate embodiment of the fabrication process described with respect to FIG. 6. FIG. 8A illustrates formation of a fiber array core with additional structural features, FIG. 8B illustrates introduction of cladding resin into the fiber array core, and FIG. 8C illustrates a released fiber array following removal from a substrate. Similar to the embodiment of FIGS. 7A-7C, a fiber array core 805 may be formed on a substrate 802 with a sacrificial structure 803 disposed therebetween. In this embodiment, the sacrificial structure 803 is configured to support overhanging portions of the fiber array core 805 during fabrication, particularly in configurations where portions of the fiber array core 805 are suspended or extend laterally. A supporting frame 810 may also be provided to maintain structural integrity of the fiber array core 805 during the build process.

Referring to FIG. 8A, a first operation 610 comprises building the fiber array core 805 on the substrate 802. In some embodiments, the fiber array core 805 is formed over the sacrificial structure 803 disposed on the substrate 802. As illustrated in FIG. 8A, one or more structural features, including the supporting frame 810 and one or more relief vents 811, may be formed concurrently with or adjacent to the fiber array core 805. The supporting frame 810 is configured to maintain structural integrity of the fiber array core 805 during fabrication, while the relief vents 811 are positioned to facilitate subsequent material flow during later operations.

Referring to FIG. 8B, a second operation 620 comprises removing excess resin and cleaning the fiber array core 805. Cleaning may expose interstitial regions between fiber cores and prepare the structure for subsequent material introduction. A third operation 630 comprises filling the fiber array core 805 with a cladding resin 852. As illustrated in FIG. 8B, which shows a cross-sectional view during cladding introduction, the cladding resin 852 may be introduced through one or more cladding fill ports 851 to surround the fiber cores. The one or more relief vents 811 facilitate displacement of air and/or excess resin during introduction of the cladding resin 852, thereby enabling more complete and uniform filling of regions surrounding the fiber array core 805.

Referring to FIG. 8C, a fourth operation 640 comprises retrieving the fiber array from the substrate 802. In some embodiments, retrieving the fiber array comprises separating the fiber array core 805 from the substrate 802 by removing or otherwise releasing the sacrificial structure 803. As illustrated in FIG. 8C, which shows a released fiber array including supporting structures, the supporting frame 810 maintains structural integrity of the fiber array core 805 during and after release.

A fifth operation 650 comprises polishing one or more ends of the fiber array to form polished end surfaces suitable for optical coupling. As further illustrated in FIG. 8C, polishing may be performed on the fiber array core 805 and surrounding materials after release. A sixth operation 660 comprises attaching one or more alignment members to the fiber array. In some embodiments, the alignment members may be coupled to one or more ends of the fiber array following polishing, consistent with embodiments described with respect to FIG. 4.

The implementation illustrated in FIGS. 8A-8C provides an alternative structural configuration for performing the fabrication process 600. In some embodiments, use of the cladding fill ports 851 and the relief vents 811 facilitates controlled introduction of the cladding resin 852 and removal of displaced material, thereby reducing void formation and improving uniformity of the cladding region. The sacrificial structure 803 enables support of overhanging features during fabrication, while the supporting frame 810 provides mechanical reinforcement of the resulting fiber array.

FIG. 9 illustrates an embodiment of a fiber array structure formed on a substrate and subsequently processed, consistent with the fabrication processes described herein. FIG. 9 shows a fiber array core disposed on a substrate with surrounding cladding material, with FIG. 9 providing a structural example corresponding to one or more of the operations described with respect to FIG. 6.

As illustrated in FIG. 9, a fiber array core 905 may be formed on a substrate 902. In some embodiments, the fiber array core 905 is formed over a sacrificial layer 903 disposed on the substrate 902. The fiber array core 905 may comprise a plurality of fiber cores arranged in a desired pattern or density, as described with respect to FIGS. 3 and 6.

In some embodiments, a cladding resin 952 may be introduced to surround the fiber array core 905. The cladding resin 952 may fill interstitial regions between fiber cores of the fiber array core 905 to provide optical confinement and structural support. The cladding resin 952 may be introduced following cleaning of the fiber array core 905, consistent with the second and third operations 620 and 630 described with respect to FIG. 6.

The embodiment illustrated in FIG. 9 provides a structural representation of a fiber array during or after cladding formation while supported on the substrate 902. In some embodiments, the sacrificial layer 903 may subsequently be removed to release the fiber array from the substrate 902, as described with respect to the fourth operation 640. The resulting structure may then be further processed, including polishing and attachment of alignment members, consistent with operations 650 and 660.

The structure shown in FIG. 9 demonstrates formation of a fiber array core and surrounding cladding on a substrate in a manner that supports subsequent release and integration, and may correspond to intermediate or final stages of the fabrication process depending on implementation.

FIGS. 10A-10C illustrate an optical system including a fiber array integrated with electronic and optical components, consistent with embodiments of the present disclosure. FIGS. 10A-10C show integration of a fiber array with a backplane and light emitting devices, with FIG. 10A showing a system-level arrangement including a backplane 1001, a plurality of micro-light emitting devices (micro-LEDs) 1003, and a fiber array 1005, FIG. 10B showing an alignment and attachment interface including a connector 1060, fiducials 1062, and adhesive material (e.g. glue) 1064, and FIG. 10C showing a cross-sectional view of the integrated structure including a cladding layer 1052, isolations 1066, and sacrificial structures 1068.

As illustrated in FIG. 10A, the fiber array 1005 may be positioned relative to the backplane 1001 and the plurality of micro-LEDs 1003 such that individual fibers of the fiber array 1005 are aligned with corresponding light emitting elements. In some embodiments, one or more optical elements, such as microlenses, may be disposed over the plurality of micro-light emitting devices 1003 to facilitate optical coupling into the fiber array 1005. The fiber array 1005 may correspond to the fiber arrays described with respect to FIGS. 3-9 and may comprise fiber cores surrounded by a cladding layer 1052 configured to provide optical confinement. In some embodiments, the backplane 1001 provides electrical interconnection and support for the micro-LEDs 1003, while the fiber array 1005 facilitates transmission of optical signals. In some embodiments, the fiber array 1005 may be fabricated directly onto the backplane 1001 using one or more of the fabrication processes described herein, thereby reducing assembly steps and improving alignment accuracy.

As illustrated in FIG. 10B, which shows an alignment and attachment interface for the fiber array, one or more connectors 1060 may be used to position and couple the fiber array 1005 relative to the backplane 1001 and associated components. In some embodiments, fiducials 1062 are provided on the fiber array 1005, the connector 1060, the backplane 1001, or combinations thereof to facilitate alignment using optical or mechanical alignment systems. The fiducials 1062 may comprise optically detectable patterns or geometric reference features that enable precise positioning of the fiber array 1005 relative to the micro-LEDs 1003. In some embodiments, an adhesive material 1064 may be applied to secure the fiber array 1005 and/or the connector 1060 in a desired position following alignment.

As illustrated in FIG. 10C, which shows a cross-sectional view of the integrated structure, the fiber array 1005 comprises the cladding layer 1052 surrounding the fiber cores and may further comprise structures within the isolations 1066 disposed between adjacent regions to reduce optical cross-talk or to provide electrical or mechanical separation. In some embodiments, sacrificial structures 1068 may be present during fabrication and may be removed prior to or during integration of the fiber array 1005 with the backplane 1001. Removal of the sacrificial structures 1068 may facilitate formation of desired geometries or interfaces for coupling the fiber array 1005 to other components.

The embodiments illustrated in FIGS. 10A-10C demonstrate integration of the fiber array 1005 with system-level components to form an optical system. In some embodiments, the use of fiducials 1062, connectors 1060, and adhesive material 1064 facilitates precise alignment and secure attachment of the fiber array 1005, thereby improving coupling efficiency and reducing variability during assembly. The integrated structure may leverage fabrication techniques described herein to provide improved alignment, reduced defect formation, and enhanced performance in optical systems.

Embodiments of the present disclosure provide a number of benefits. In some embodiments, formation of fiber array structures using integrated fabrication techniques described herein enables improved control of fiber geometry, spacing, and alignment, particularly for high-density fiber arrays. In some embodiments, removal of uncured materials and controlled introduction of cladding materials facilitates uniform filling of interstitial regions, thereby reducing void formation and improving optical performance. In some embodiments, integration of alignment features, connectors, and fiducials with the fiber array reduces assembly complexity and alignment variability, which may improve coupling efficiency and manufacturing yield. In some embodiments, incorporation of supporting structures and controlled release techniques may enhance structural integrity during handling and integration.

While the foregoing is directed to embodiments of the present disclosure, other and further embodiments of the present disclosure may be devised without departing from the basic scope thereof, and the scope thereof is determined by the claims that follow. In addition, embodiments of the present disclosure may be implemented in various combinations and sub-combinations of features described herein. Further, the use of directional terms such as “above,” “below,” “upper,” “lower,” and the like is for convenience of description and does not require any particular orientation of the elements described. Similarly, terms such as “coupled,” “connected,” or “disposed” are intended to encompass both direct and indirect relationships, unless otherwise indicated.

What is claimed is:

1. A method of forming a fiber array, comprising:
introducing a core resin into a build volume between a base support and a build stage;
selectively curing portions of the core resin using a light-based curing system to form a plurality of cured resin cores;
introducing a cladding resin into the build volume;
curing the cladding resin to form a cured cladding resin surrounding the plurality of cured resin cores; and
actuating the build stage relative to the base support along a build direction to build a three-dimensional fiber array structure to a build height.

2. The method of claim 1, wherein the light-based curing system comprises a digital light projection module.

3. The method of claim 1, wherein the light-based curing system comprises a laser-based scanning system.

4. The method of claim 1, wherein the core resin comprises a higher refractive index material than the cladding resin.

5. The method of claim 1, wherein the cladding resin is introduced to substantially fill interstitial regions between the plurality of cured resin cores.

6. The method of claim 1, further comprising repeatedly introducing additional core resin, selectively curing portions of the additional core resin, introducing the cladding resin, and curing the cladding resin while actuating the build stage until a desired build height is reached.

7. The method of claim 1, further comprising introducing a protective resin into the build volume and curing the protective resin to form a cured protective resin surrounding the cured cladding resin.

8. The method of claim 7, further comprising forming an alignment member integrally with the fiber array using one or more structural resins.

9. The method of claim 8, wherein the alignment member comprises one or more fiducial features configured to provide reference points for alignment of the fiber array relative to an external component.

10. A method of forming a fiber array, comprising:
building a fiber array core on a substrate;
removing excess resin and cleaning the fiber array core;
filling the fiber array core with a cladding resin;
retrieving the fiber array core from the substrate;
polishing one or more ends of the fiber array core; and
attaching one or more alignment members to the fiber array core.

11. The method of claim 10, wherein the fiber array core is built over a sacrificial layer disposed on the substrate, and retrieving the fiber array core from the substrate comprises removing or otherwise releasing the sacrificial layer.

12. The method of claim 10, wherein filling the fiber array core with the cladding resin comprises introducing the cladding resin through one or more cladding fill ports.

13. The method of claim 12, further comprising removing excess resin during introduction of the cladding resin through one or more relief vents.

14. The method of claim 10, wherein removing the excess resin and cleaning the fiber array core comprises removing uncured material from interstitial regions between fiber cores.

15. The method of claim 10, wherein the one or more alignment members comprises one or more fiducial features configured to facilitate alignment of the fiber array relative to an external optical component.

16. An optical system, comprising:
a backplane;
a plurality of micro-light emitting devices disposed relative to the backplane; and
a fiber array positioned relative to the backplane and the plurality of micro-light emitting devices such that individual fibers of the fiber array are aligned with corresponding light emitting elements of the plurality of micro-light emitting devices to optically couple light from the plurality of micro-light emitting devices into the fiber array,
wherein the fiber array comprises a plurality of fiber cores and a cladding layer surrounding the plurality of fiber cores.

17. The optical system of claim 16, further comprising one or more connectors configured to position and couple the fiber array relative to the backplane.

18. The optical system of claim 16, further comprising fiducials configured to facilitate alignment of the fiber array relative to the backplane.

19. The optical system of claim 16, further comprising glue configured to secure the fiber array in a desired position following alignment.

20. The optical system of claim 16, further comprising isolations disposed between adjacent regions to reduce optical cross-talk or to provide electrical separation or mechanical separation.
